(19) United States
(12) Patent Application Publication
(10) Pub. No.: US 2019/0334457 A1
(43) Pub. Date: Oct. 31, 2019

(54) SINUSOIDAL MODULATION METHOD AND THREE PHASE INVERTER

(71) Applicant: NATIONAL CHIAO TUNG UNIVERSITY, HSINCHU CITY (TW)

(72) Inventors: Shyr-Long JENG, Qionglin Township (TW); Chih-Chiang WU, Hsinchu City (TW); Wei-Hua CHIENG, Hsinchu City (TW)

(21) Appl. No.: 16/180,636

(22) Filed: Nov. 5, 2018

(30) Foreign Application Priority Data
Apr. 26, 2018 (TW) 107114321

(51) Int. Cl. H02M 7/5387

(52) U.S. Cl. CPC H02M 7/53871

(57) ABSTRACT

A sinusoidal modulation method and a three-phase inverter are disclosed. A pulse driving signal controller is disposed to connect the three-phase inverter. The pulse driving signal controller controls the transistors of the three-arm full-bridge architecture. By examining the phase angle of the output current, operations of the upper and lower bridge power transistors can be adjusted, so that three power transistors are turned on and the other three power transistors are turned off during the PWM operations. As a result, the dead time is not required to set during the PWM operation for preventing a short-circuit due to dynamic switching errors of the upper and lower bridge power transistors. The requirements of the hardware circuits can be also reduced.

### CROSS-REFERENCE TO RELATED APPLICATION

This application claims the benefit of Taiwan Patent Application No. 107114321, filed on Apr. 26, 2018, in the Taiwan Intellectual Property Office, the disclosure of which is incorporated herein in its entirety by reference.

### BACKGROUND OF THE INVENTION

### 1. Field of the Invention

The present invention generally relates to a sinusoidal modulation method and a three-phase inverter using the same, more particularly to a no-dead-time sinusoidal modulation method which is able to adjust operations of upper and lower bridge power transistors according to a sinusoidal current phase angle, and a three-phase inverter using the same.

### 2. Description of the Related Art

The existing three-phase AC sine-wave driver can be used to a motor or a DC/AC inverter. In recent years, the conventional driving methods are sinusoidal pulse width modulation (SPWM) and space vector pulse width modulation (SVPWM). These manners all use complementary switching operations of upper and lower bridge power transistors. When the upper bridge power transistor is turned on, the lower bridge power transistor is turned off; and, when the lower bridge power transistor is turned on, the upper bridge power transistor is turned off, so as to prevent the upper and lower bridge power transistors from being turned on at the same time to cause a short circuit and damage the power transistor. However, when the upper and lower bridge power transistors are switched quickly based on the pulse width modulation (PWM) signal, their dv/dt dynamic effect often increases the instability of the transistor gate drive circuit to cause erroneous conduction, and it results in an instantaneous short circuit of the drive circuit which may burn or damage the power transistors.

In order to solve the above problems, the existing SPWM or SVPWM modulation method must add a delay time (that is, dead time) for the operations of the bridge power transistors. When the upper bridge power transistor is to be turned on, the lower bridge power transistor must be turned off early to prevent the problem that the upper and lower bridge power transistors are turned on at the same time during the switching operation. Furthermore, in order to prevent an accidental short circuit, some protection circuits must be added to the hardware circuit. In addition, the SPWM or SVPWM modulation method generally uses the dead time of about 1 μs; however, as the switching frequency of the PWM carrier increases, the dead time may cause distortion of the waveform and affect the conversion efficiency.

Therefore, what is needed is to develop a no-dead-time sinusoidal modulation method and a three-phase inverter using the same to solve above-mentioned problems.

### SUMMARY OF THE INVENTION

In order to solve aforementioned technical problems, the present invention provides a sinusoidal modulation method and a three-phase inverter using the same. In the sinusoidal modulation method, it is not necessary to setup a dead time during switching operations of the upper and lower bridge power transistors, so as to solve the problem of a short-circuit of the power source to ground causing high current damaging circuit elements when the upper and lower arm circuits are turned on.

According to an embodiment, the present invention provides a sinusoidal modulation method adapted to a three-phase inverter including three phase arms, and each of the three phase arms includes two bridge arms controlled by a lower bridge transistor and an upper bridge transistor, respectively. The sinusoidal modulation method includes steps of: disposing a pulse driving signal controller electrically connected to the upper bridge transistors and the lower bridge transistors of the three phase arms; inputting a phase angle and a triangular carrier wave, and calculating duty cycles corresponding to the three phase arms, respectively, according to a modulation index, the phase angle and the triangular carrier wave; determining, by using the pulse driving signal controller for each of the three phase arms, whether a sinusoidal control signal corresponding to the phase angle is positive, wherein when the sinusoidal control signal corresponding to the phase angle is positive, the upper bridge transistor is turned on and the lower bridge transistor is turned off, and when the sinusoidal control signal corresponding to the phase angle is not positive, the upper bridge transistor is turned off and the lower bridge transistor is turned on; determining by using the pulse driving signal controller, for each of the three phase arms, under a condition that the upper bridge transistor is turned on, whether the duty cycle is higher than the triangular carrier wave, wherein when the duty cycle is higher than the triangular carrier wave, an upper bridge turn-on signal is output to the upper bridge transistor, and when the duty cycle is not higher than the triangular carrier wave, an upper bridge turn-off signal is outputted to the upper bridge transistor; and determining by using the pulse driving signal controller, for each of the three phase arms, under a condition that the lower bridge transistor is turned on, whether the duty cycle is higher than the triangular carrier wave, wherein when the duty cycle is higher than the triangular carrier wave, a lower bridge turn-off signal is outputted to the lower bridge transistor, and when the duty cycle is not higher than the triangular carrier wave, a lower bridge turn-on signal is outputted to the lower bridge transistor.

Preferably, the output terminal of the three-phase inverter may be serially connected to an inductive circuit including an inductor and a resistor, and a phase-shift angle of current lagging voltage is obtained by detecting an inductive reactance of the inductor and a resistance value of the resistor.

Preferably, the phase-shift angle may be subtracted from the phase angle.

Preferably, the phase angles of the three phase arms may be different from each other by 120°, and the phase-shift angle is about 51.5°.

Preferably, an output terminal of the three-phase inverter may be electrically connected to a voltage detection circuit and a current detection circuit configured to detect three-phase voltages and three-phase currents, respectively, and the three-phase voltages and the three-phase currents are transmitted back to the pulse driving signal controller through a feedback control circuit.

According to an embodiment, the present invention provides a three-phase inverter including three phase arms and a pulse driving signal controller. Each of the three phase arms includes two bridge arms, and two bridge arms are controlled by a lower bridge transistor and an upper bridge transistor, respectively. The pulse driving signal controller is electrically connected the upper bridge transistors and the lower bridge transistors of the three phase arms. For each of the three phase arms, the pulse driving signal controller performs operations of determining whether a sinusoidal control signal of a phase angle is positive, and turning on the upper bridge transistor and turning off the lower bridge transistor, or turning off the upper bridge transistor and turning on the lower bridge transistor according to determination result; and according to whether a duty cycle corresponding to the phase angle is higher than a triangular carrier wave, transmitting a pulse control signal to the turned-on upper bridge transistor or the turned-on lower bridge transistor.

Preferably, an output terminal of the three-phase inverter may be serially connected to an inductive circuit including an inductor and a resistor.

Preferably, a phase-shift angle of a current lagging the voltage may be subtracted from the phase angle.

Preferably, the phase angles of the three phase arms may be different from each other by 120°, and the phase-shift angle is about 51.5°.

Preferably, an output terminal of the three-phase inverter may be electrically connected to a voltage detection circuit and a current detection circuit configured to detect three-phase voltages and three-phase currents, and the three-phase voltages and three-phase currents are transmitted to the pulse driving signal controller through a feedback control circuit.

According to above-mentioned contents, the present invention provides the no-dead-time sinusoidal modulation method and the three-phase inverter having at least one of the following advantages.

First, the no-dead-time sinusoidal modulation method and the three-phase inverter can use the sinusoidal control signal to turn on or turn off the upper bridge transistor and the lower bridge transistor, so that, in the three phase arms, the three transistors are turned on and the other three power transistors are turned off in every period, so as to reduce switching losses of the power transistors and improve use efficiency.

Secondly, the no-dead-time sinusoidal modulation method and the three-phase inverter can control the upper and lower arms of each phase arm by different operations, so it is not necessary to set the dead time for switching operations of transistors of the upper and lower arms for preventing the upper and lower arms from being burn because of short circuit; furthermore, the conventional problem that the dead time causes the shift of the pulse signal can also be solved.

Thirdly, the no-dead-time sinusoidal modulation method and the three-phase inverter can control the upper and lower bridge power transistors without adding hardware circuit or protection circuit, so as to effectively reduce hardware cost.

### BRIEF DESCRIPTION OF THE DRAWINGS

The structure, operating principle and effects of the present invention will be described in detail by way of various embodiments which are illustrated in the accompanying drawings.

FIG. 1 is a flow chart of a sinusoidal modulation method of an embodiment of the present invention.

FIG. 2 is a circuit diagram of a three-phase inverter of an embodiment of the present invention.

FIG. 3 is a schematic view of modulation waveforms at different work areas of an embodiment of the present invention.

FIG. 4 shows simulated waveforms of phase currents of an embodiment of the present invention, before and after the phase currents are corrected according to a phase-shift angle.

FIG. 5 is a schematic view of PWM driving signals of upper and lower bridge power transistors of an embodiment of the present invention.

FIG. 6 is a schematic view of three-phase voltages of a three-phase sinusoidal modulation method of an embodiment of the present invention.

FIG. 7 is a circuit diagram of an application of a three-phase inverter of an embodiment of the present invention.

FIGS. 8A to 8E are circuit diagrams of an application of a three-phase inverter of another embodiment of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be understood that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be understood to imply the inclusion of stated elements but not the exclusion of any other elements.

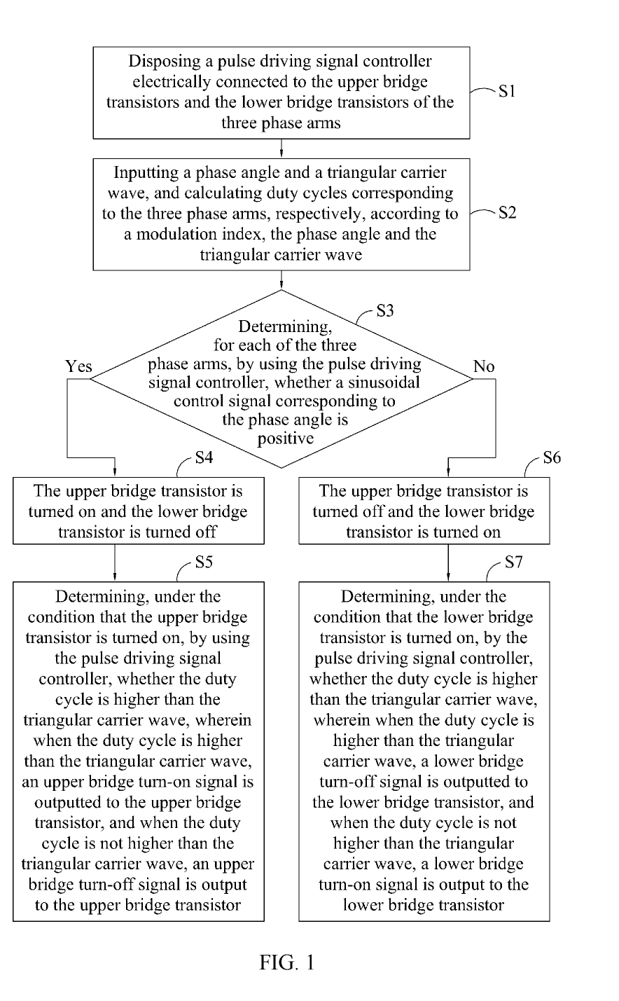

Please refer to FIG. 1, which is a flow chart of a sinusoidal modulation method of an embodiment of the present invention. The method includes steps S1 to S7.

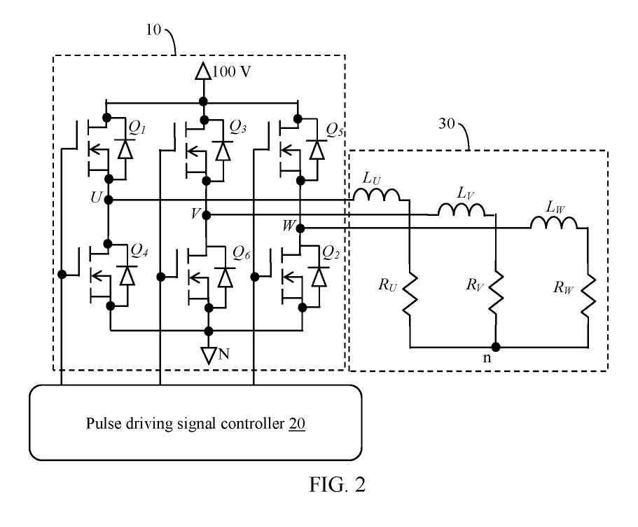

In step S1, a pulse driving signal controller is electrically connected to upper bridge transistors and lower bridge transistors of three phase arms. The sinusoidal modulation method of this embodiment is applicable to a three-phase inverter. Please refer to FIG. 2, which is a circuit diagram of the three-phase inverter of an embodiment of the present invention. The three-phase inverter 10 includes three phase arms U, V, and W, and each of the three phase arms U, V, and W includes an upper bridge arm and a lower bridge arm. The phase arm U is controlled by a lower bridge transistor Q4 and an upper bridge transistor Q1, the phase arm V is controlled by a lower bridge transistor Q6 and an upper bridge transistor Q3, the phase arm W is controlled by a lower bridge transistor Q2 and an upper bridge transistor Q5. The pulse driving signal controller 20 is connected to the gates of the upper bridge transistors Q1, Q3 and Q5 and the lower bridge transistors Q2, Q4 and Q6. The pulse driving signal controller 20 can transmit the three-phase pulse driving modulation signal to turn on or off the upper bridge transistors Q1, Q3 and Q5, and the lower bridge transistors Q4, Q6 and Q2. The output terminal of the three-phase inverter 10 can be serially connected to the inductive circuit 30, and the three phase arms U, V, and W are connected to inductors L_{U}, L_{V} and L_{W} and resistors R_{U}, R_{V} and R_{W}, respectively. In this embodiment, the inductive circuit serves as a load of the three-phase inverter 10, but the present invention is not limited thereto. In other embodiment, the three-phase inverter 10 can be electrically connected to a power factor correction circuit with feedback control function, and the content of this embodiment will be described in the following paragraph.

In step S2, a phase angle and a triangular carrier wave are input, and the duty cycles corresponding to the three phase arms are calculated according to a modulation index, the phase angle and the triangular carrier wave. The parameter related to the pulse and the phase angle of synchronous vector corresponding to pulse are inputted into the pulse driving signal controller 20 to calculate the duty cycle of the pulse width modulation. When DC power source 100 supplies power, the pulse driving signal controller 20 selects switching modes of the six power switch elements to generate a pulse width modulation wave, thereby making the output waveform of the three-phase inverter 10 approximate to an ideal circle.

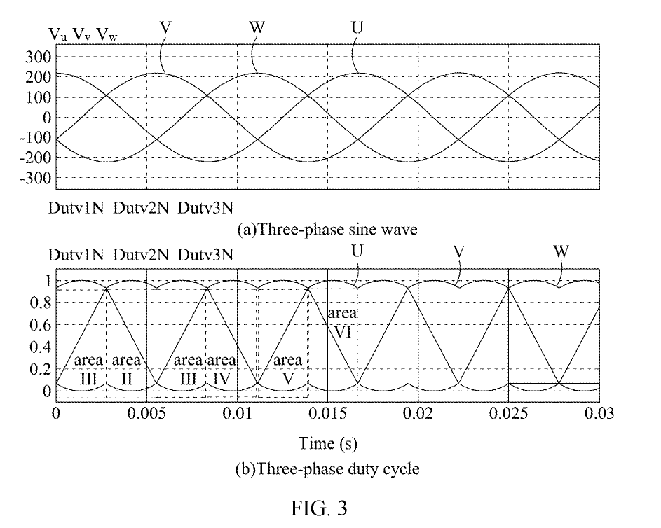

In this embodiment, whole plane area of space vector is divided into six sector areas I to VI. Please refer to FIG. 3, which is a schematic view of modulation waveforms in different work areas. Every time the three-phase sinusoidal output phase angle is increased by 60 degrees, the output duty cycles of the three phase arms U, V, and W in the six areas are adjusted until the synchronous vector rotates a circle completely. The phase voltages of the three phase arms U, V, and W are maintained to be different from each other by 120°, and the output phase voltages of the three phase arms U, V, and W can be adjusted and controlled according to different work areas and different duty cycle equations. In this embodiment, table 1 shows the duty cycles D_{U}, D_{V}, and D_{W} performed by the three phase arms U, V, and W when the phase angle θ of the signal vector is in one of different areas I to VI.

| Sector area | Duty cycles of PWM modulations |
|---|---|
| (input phase angle) | for three phase arms |
| I: (0°~60°) IV: (180°~240°) | ${D}_{U} = \frac{1}{2} + \frac{1}{2} m \cdot cos ( θ - \frac{π}{6} )$ |
| | ${D}_{V} = \frac{1}{2} + \frac{\sqrt{3}}{2} m \cdot sin ( θ - \frac{π}{6} )$ |
| | ${D}_{W} = \frac{1}{2} - \frac{1}{2} m \cdot cos ( θ - \frac{π}{6} )$ |
| II: (60°~120°) V: (240°~300°) | ${D}_{U} = \frac{1}{2} + \frac{\sqrt{3}}{2} m \cdot cos ( θ )$ |
| | ${D}_{V} = \frac{1}{2} + \frac{1}{2} m \cdot sin ( θ )$ |
| | ${D}_{W} = \frac{1}{2} - \frac{1}{2} m \cdot sin ( θ )$ |
| III: (120°~180°) VI: (300°~360°) | ${D}_{U} = \frac{1}{2} + \frac{1}{2} m \cdot cos ( θ + \frac{π}{6} )$ |
| | ${D}_{V} = \frac{1}{2} - \frac{1}{2} m \cdot cos ( θ + \frac{π}{6} )$ |
| | ${D}_{W} = \frac{1}{2} - \frac{\sqrt{3}}{2} m \cdot cos ( θ - \frac{π}{3} )$ |

wherein m is a modulation index, and a value of m is between 0 and 1, and a value of each of duty cycles D_{U}, D_{V}, and D_{W} is also between 0 and 1. For example, when the duty cycle D_{U} is 1, the voltage on an output terminal of the phase arm U is Vdc, and Vdc is a DC BUS of the inverter and can be 100V with a frequency of 60 Hz; when the duty cycle D_{U} is 0, the voltage on the output terminal of the phase arm U is 0. As a result, the voltages on the output terminals of the three phase arms U, V, and W relative to Vdc can be expressed by the equations (1) to (3) below.

$$\begin{matrix}{V}_{UN} = {V}_{dc} ( \frac{1}{2} + \frac{1}{2} m \cdot cos ( θ - \frac{π}{6} ) ) & ( 1 ) \\ {V}_{VN} = {V}_{dc} ( \frac{1}{2} + \frac{\sqrt{3}}{2} m \cdot sin ( θ - \frac{π}{6} ) ) & ( 2 ) \\ {V}_{WN} = {V}_{dc} ( \frac{1}{2} - \frac{1}{2} m \cdot cos ( θ - \frac{π}{6} ) ) & ( 3 )\end{matrix}$$

As shown in FIG. 2, each phase voltage of the load can be obtained by calculating a potential difference between a neutral point n of the load and a hypothetical midpoint of the DC power N. The voltage V_{nN} on the neutral point n is an average value of the voltages on the output terminals of the three phase arms U, V, and W, and can be expressed as

$${V}_{nN} = {V}_{dc} ( \frac{1}{2} + \frac{\sqrt{3}}{6} m \cdot sin ( θ - \frac{π}{6} ) ) ,$$

the phase voltages of the three phase arms U, V, and W can be expressed by equations (4) to (6) below, respectively.

$$\begin{matrix}{V}_{Un} = {V}_{UN} - {V}_{nN} = \frac{\sqrt{3} {V}_{dc} \cdot m}{3} cos ( θ ) & ( 4 ) \\ {V}_{Vn} = {V}_{VN} - {V}_{nN} = \frac{\sqrt{3} {V}_{dc} \cdot m}{3} cos ( θ - \frac{2 π}{3} ) & ( 5 ) \\ {V}_{Wn} = {V}_{WN} - {V}_{nN} = \frac{\sqrt{3} {V}_{dc} \cdot m}{3} cos ( θ + \frac{2 π}{3} ) & ( 6 )\end{matrix}$$

According above equations, the phase voltages of the three phase arms U, V, and W outputted from the inverter are different from each other by 120° in each sector area. When modulation index m is at the maximum value of 1, the maximum amplitude of the sin wave is

$$\frac{\sqrt{3}}{3} {V}_{dc} .$$

The three-phase sinusoidal modulation method of this embodiment, the duty cycles D_{U}, D_{V}, and D_{W} of the three phase arms U, V, and W can be calculated according to the sinusoidal output voltage in different phase angles θ. The upper and lower bridge power transistors can be controlled to perform positive PWM operation and negative PWM operation for complementary modulation switching, respectively. The modulation method can be performed without considering a direction of the output current, setting the delay time (that is, the dead time), and increasing complexity of the hardware circuit of the inverter. When the output current in the fly-back stage, a bypass diode of the power transistor can be turned on, so that the requirement in the dead time of the bridge structure can be omitted.

In step S3, for each phase arm, the pulse driving signal controller can determine whether a sinusoidal control signal corresponding to the phase angle is positive, and when yes, the step S4 is performed; otherwise, the step S6 is performed. The pulse driving signal controller 20 receives the information of the phase angle θ, the modulation index m and the triangular carrier wave area Vₜᵣᵢ which is an amplitude of a PWM triangular carrier wave with a normalized amplitude between 0 and 1 and a carrier frequency of 10 kHz, so the switching operation of the upper bridge switch and the lower bridge switch can be determined according to whether the sinusoidal control signal of the phase angle θ is positive.

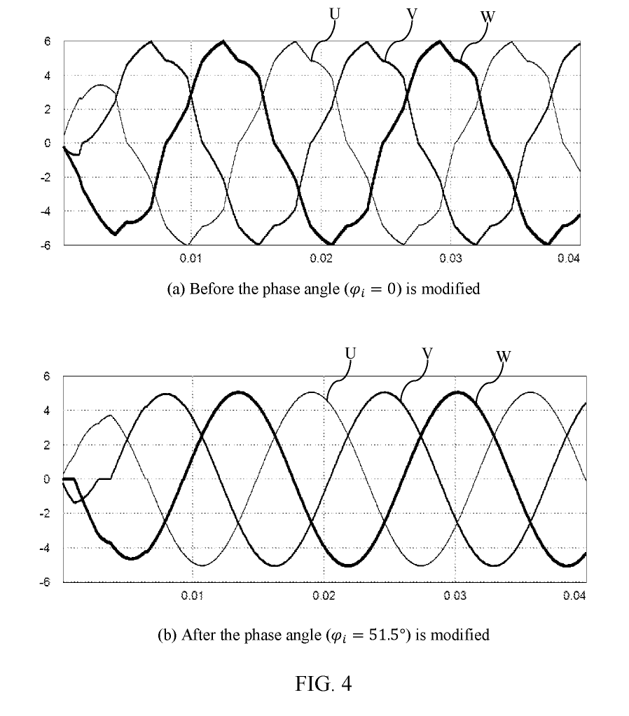

In this embodiment, the output terminal of the three-phase inverter 10 is serially connected to the inductive circuit 30. The inductor has a characteristic against a change in current and is able to store energy of the power source in magnetic manner, so the current of the inductor lags behind the voltage of the inductor with a phase-shift angle of 90° and leads the voltage of the power source with a phase-shift angle φ; as a result, the phase angle φ can be subtracted from the phase angle θ to make the waveform of the output phase current more complete. The relationship between the amplitudes and the phases of the voltage and the current are determined by the resistance value and the inductive reactance of the inductor, and the calculation equations of the phase angle φᵢ of the current lagging the voltage can be expressed as the equations (7) and (8) below.

$$\begin{matrix}{Z}_{i} = {R}_{i} + j ( 2 π f ) {L}_{i} & ( 7 ) \\ {ϕ}_{i} = {tan}^{- 1} \frac{( 2 π f ) {L}_{i}}{{R}_{i}} & ( 8 )\end{matrix}$$

wherein Zᵢ is a load impedance in the phase i, and Rᵢ is a load resistor in the phase i, and Lᵢ is a load inductor in phase i, and φᵢ is a phase-shift angle in phase i, and f is an operating frequency, and i can be U, V or W. In this embodiment, the Rᵢ=3.55Ω, Lᵢ=11.86 mH and f=60 Hz, and those parameters can be inputted into above equations to obtain about 51.5 degree of the phase-shift angle φᵢ of the current lagging voltage. Please refer to FIG. 4, which shows simulated waveforms of the phase currents before and after the phase angles of the phase currents are modified according to the phase-shift angle. FIG. 4 shows the current expressed as a sine wave, and the phase currents of the three phase arms U, V, and W. The phase current of phase arm V lags behind the phase current of the phase arm U by 120 degrees, the phase current of phase arm W lags behind the phase current of the phase arm V by 120 degrees. In the sinusoidal modulation method of this embodiment, the waveform becomes more complete after the phase-shift angle φᵢ is subtracted from the phase angle, so as to reduce the shift caused by the phase angle of the current lagging voltage.

In step S3, for each phase arm, the sinusoidal control signal of the phase angle is determined whether to be positive, and when cos(θ−φ)≥0, the current is in a source direction, and step S4 is performed to turn on the upper bridge transistor and turn off the lower bridge transistor. Next, step S5 is performed, and when the upper bridge transistor is turned on, the pulse driving signal controller can determine whether the duty cycle is higher than the triangular carrier wave, and if yes, the upper bridge turn-on signal is output to the upper bridge transistor; otherwise, the upper bridge turn-off signal is output to the upper bridge transistor. On the other hand, when cos(θ−φ)<0, the current is in a sink direction, and step S6 is performed to turn off the upper bridge transistor and turn on the lower bridge transistor. Next, step S7 is performed, and when the lower bridge transistor is turned on, the pulse driving signal controller can determine whether the duty cycle is higher than the triangular carrier wave, and if yes, the lower bridge turn-off signal is outputted to the lower bridge transistor; otherwise, the lower bridge turn-on signal is outputted to the lower bridge transistor. The phase arm U is taken as an example to illustrate the aforementioned steps and the operations of controlling the upper bridge transistor Q1 and the lower bridge transistor Q4 of the phase arm U.

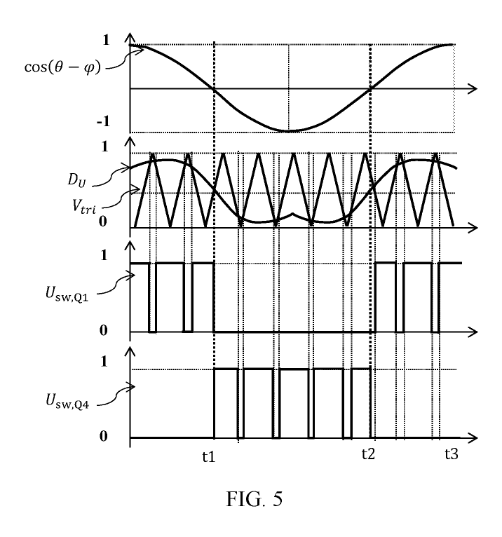

Please refer to FIG. 5, which is a schematic view of the PWM driving signals of the upper and lower bridge power transistors of an embodiment of the present invention. As shown in FIG. 5, when the sinusoidal signal of the phase arm U is positive, that is, cos(θ−φ)≥0, the pulse driving signal controller 20 can turn on the upper bridge transistor Q1 and turn off the lower bridge transistor Q4; and, when the sinusoidal signal of the phase arm U is negative, that is, cos(θ−φ)<0, the pulse driving signal controller 20 can turn off the upper bridge transistor Q1 and turns on the lower bridge transistor Q4. In other words, the upper bridge transistor Q1 is turned on for a period from time point 0 to time point t1 and a period from time point t2 to time point t3, and is turned off in a period from time point t1 to time point t2; and, the lower bridge transistor Q4 is turned on in only for a period from time point t1 to time point t2, and is turned off for the period from the time point 0 to the time point t1, and the period from the time point t2 to the time point t3. As shown in the simulation waveforms, in each sinusoidal cycle, the upper bridge transistor Q1 and the lower bridge transistor Q4 corresponding to the phase arm U can be turned on in a period of 180 degrees and turned off in a period of 180 degrees, so as to reduce the switching times of the power transistor and omit the usage of the dead time, thereby preventing the upper and lower bridge power transistors from being switched frequently in a period which causes a short-circuit condition.

In step S3, when the switching transistor is turned on, the pulse driving signal controller determines whether the duty cycle D_{U} of the phase arm U is higher than the triangular carrier wave area Vₜᵣᵢ of the PWM, and if yes, and for the period from the time point 0 to time point t1 and the period from the time point t2 to the time point t3 (that is, the sinusoidal current is in the positive half cycle), when D_{U}≥Vₜᵣᵢ, the driving signal U_{sw,Q1} with value 1 indicative of turn-on is output to the gate of the upper bridge transistor Q1; and, when D_{U}<Vₜᵣᵢ, the driving signal U_{sw,Q1} signal with value 0 indicative of turn-off is outputted to the gate of the upper bridge transistor Q1, and at this time, the lower bridge transistor Q4 is turned off. When the duty cycle D_{U} of the phase arm U is not higher than the triangular carrier wave area Vₜᵣᵢ of the PWM, in the period of the time point t1 to the time point t2 (that is, the sinusoidal current is in negative half cycle), when D_{U}≥Vₜᵣᵢ, the driving signal U_{SW,Q4} with the value of 0 indicative of turn-off is outputted to the gate of the lower bridge transistor Q4; and, when D_{U}<Vₜᵣᵢ, the driving signal U_{SW,Q4} with the value of 1 indicative of turn-on is output to the gate of the lower bridge transistor Q4, and at this time, the upper bridge transistor Q1 is turned off.

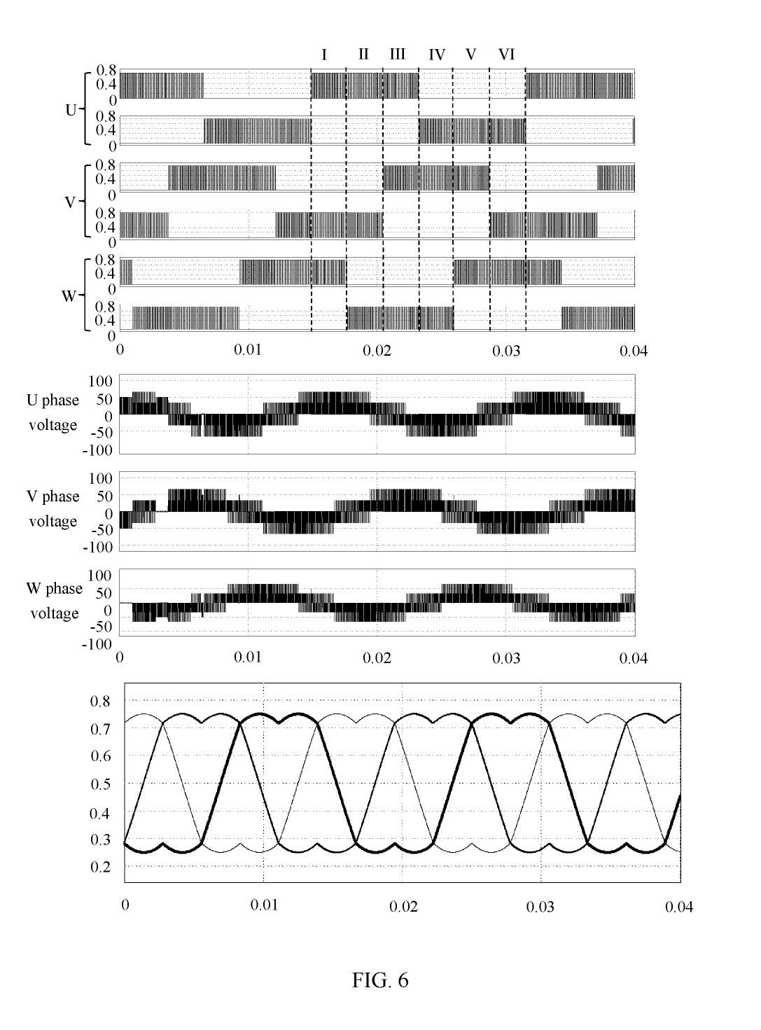

The aforementioned steps are illustrated according to phase arm U, and these steps of the determination flow are also applicable to the phase arms V and W, and the difference between the operation of the phase arm U and the operations of phase arm V and W is that the phase current of the phase arm V lags behind the phase current of the phase arm U by 120 degrees, and the phase current of phase arm W lags behind the phase current of the phase arm V by 120 degrees, as shown in FIG. 3. Please refer to FIG. 6, which is a schematic view of the three-phase voltage of modulation method of an embodiment of the present invention. As shown in FIG. 6, in the area I, the upper bridge transistors Q1 and Q5 and the lower bridge transistor Q6 are turned on; in the area II, the upper bridge transistor Q1 and the lower bridge transistors Q6 and Q2 are turned on; in the area III, bridge transistors Q1 and Q3 and the lower bridge transistor Q2 are turned on; in the area IV, the upper bridge transistor Q3 and the lower bridge transistors Q4 and Q2 are turned on; in the area V, the upper bridge transistors Q3 and Q5 and the lower bridge transistor Q4 are turned on; in the area VI, the upper bridge transistor Q5 and the lower bridge transistors Q4 and Q6 are turn on. As a result, for each period area, three power transistor switches of the six power transistor switches are turned on based on PWM signals, and the other three power transistor switches are turned off. Compared with the conventional manner that the upper and lower bridge power transistors are performed switching operations in the same period, this embodiment of the present invention can achieve the effect of reducing the switch losses of the switches. Furthermore, in the conventional manner, each PWM period is set with the dead time to prevent the upper and lower bridge power transistors from being turned on at the same time to cause short-circuiting of the DC bus during switching operations of the upper and lower bridge power transistors for protecting the power transistor switches from being burned by the short-circuit; in the present invention, this embodiment can separate the turn-on periods and turn-off periods of the upper and lower bridge power transistors of the three phase arms U, V, and W without setting the dead time, so as to achieve significant improvement in the sinusoidal waveform modulation and hardware circuit configuration.

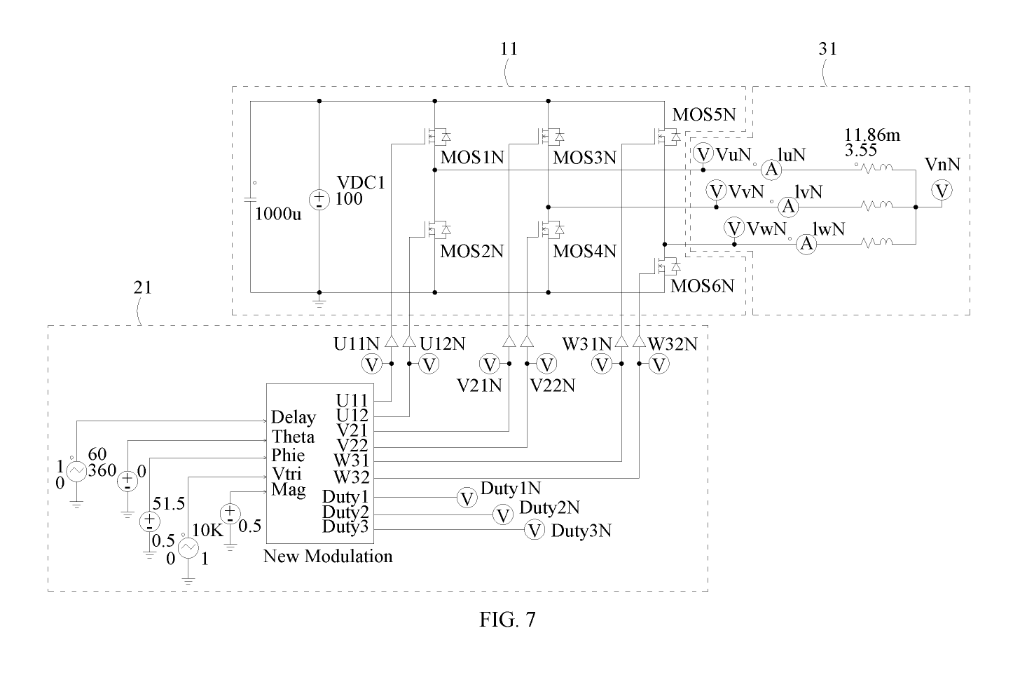

Please refer to FIG. 7, which is a circuit diagram of an application of a three-phase inverter of an embodiment of the present invention. As shown in FIG. 7, the three-phase inverter 11 is a three-phase six-arm inverter, each arm is turned on or off by a MOS transistor, and each MOS transistor is controlled by the control signal from the pulse driving signal controller 21. The load terminal of the three-phase inverter 11 is electrically connected to the inductive circuit 31 which includes an inductor and a resistor. The pulse driving signal controller 21 can be a control chip having a plurality of I/O pins and configured to receive the phase angles of the phase arms and output, according to the inputted phase angles, the turn-on control signals and turn-off control signals to the MOS transistors in corresponding periods, respectively. In this embodiment, the MOS transistor can be turned on or off according to the sinusoidal control signal corresponding to the phase angle, and when the sinusoidal control signal is positive, the MOS transistor of the upper arm is turned on, and the MOS transistor of the lower arm is turned off, and when the sinusoidal control signal is negative, the MOS transistor of the upper arm is turned off, and the MOS transistor of the lower arm is turned on.

In a condition that the MOS transistor is turned on, the pulse driving signal controller 21 can compare whether the duty cycle is higher than the triangular carrier wave, and when the MOS transistor of the upper arm is turned on, the turn-on signal is transmitted when the duty cycle is higher than the triangular carrier wave, and the turn-off signal is transmitted when the duty cycle is lower than the triangular carrier wave. In a condition that the MOS transistor of the lower arm is turned on, the turn-off signal is transmitted when the duty cycle is higher than the triangular carrier wave, and the turn-on signal is transmitted when the duty cycle is lower than the triangular carrier wave. Aforementioned control manner can refer to the description of previous embodiment, so the detailed description is not repeated herein.

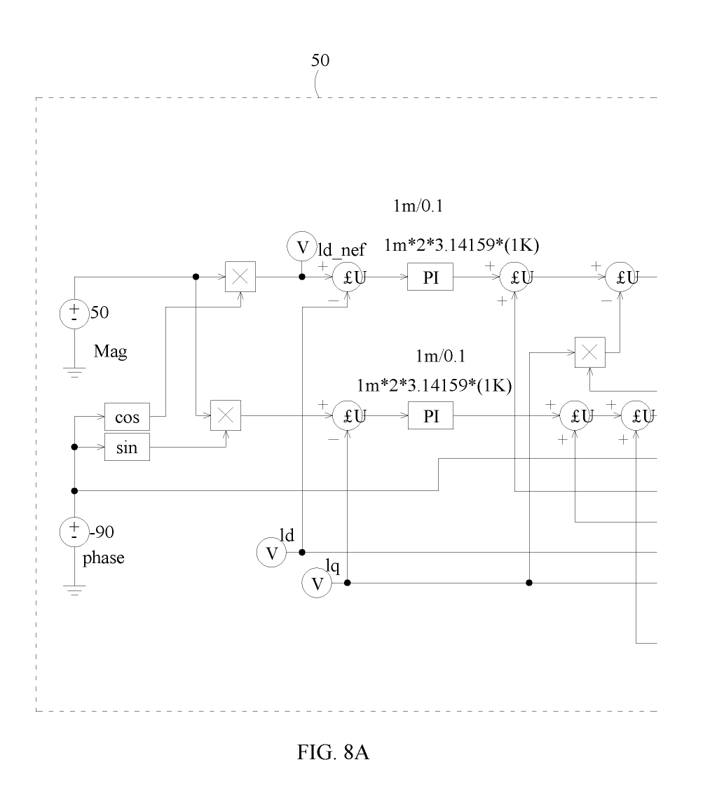

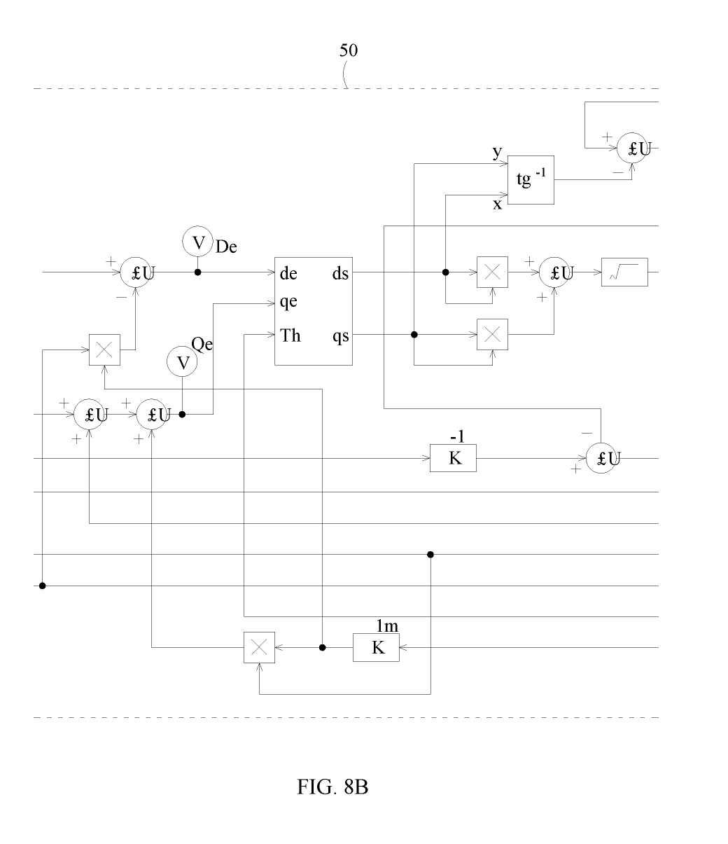

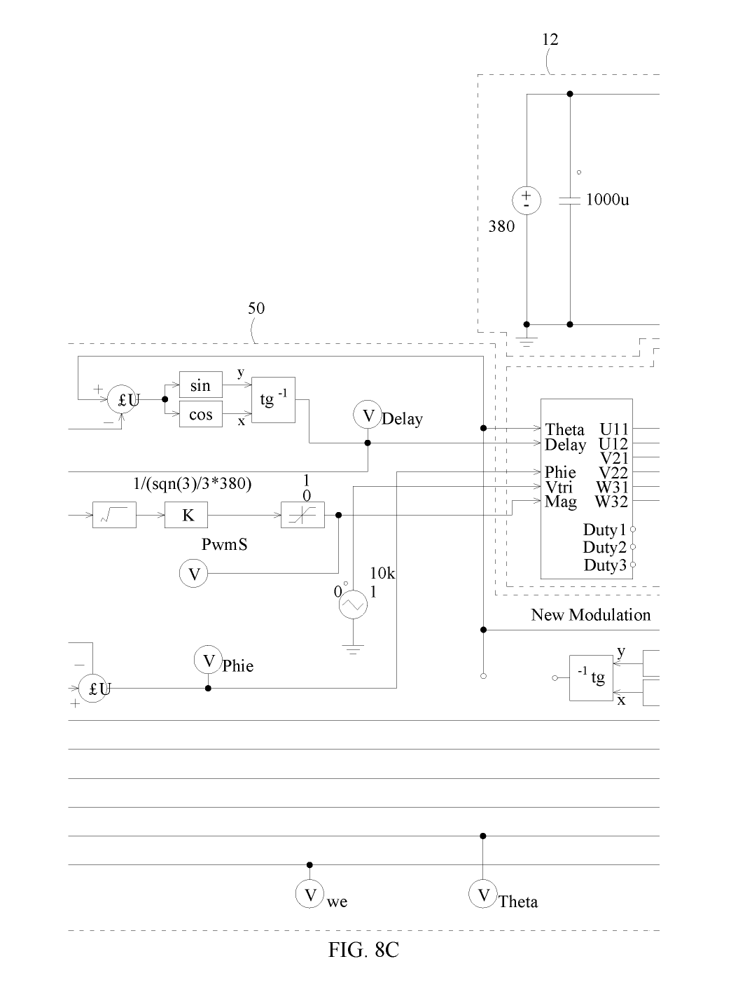

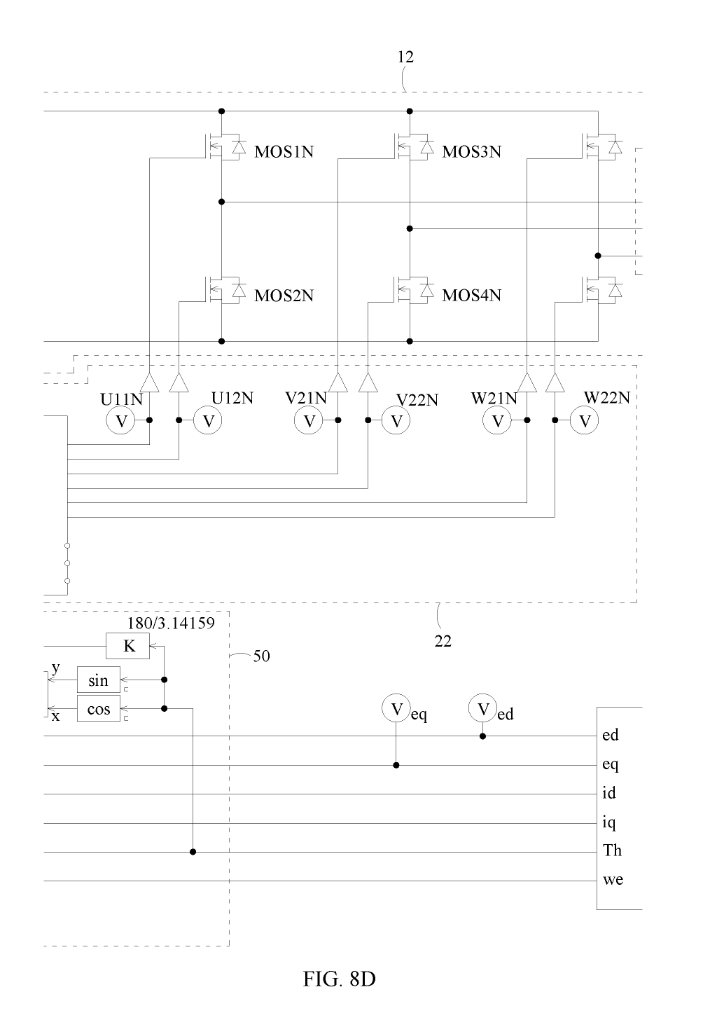

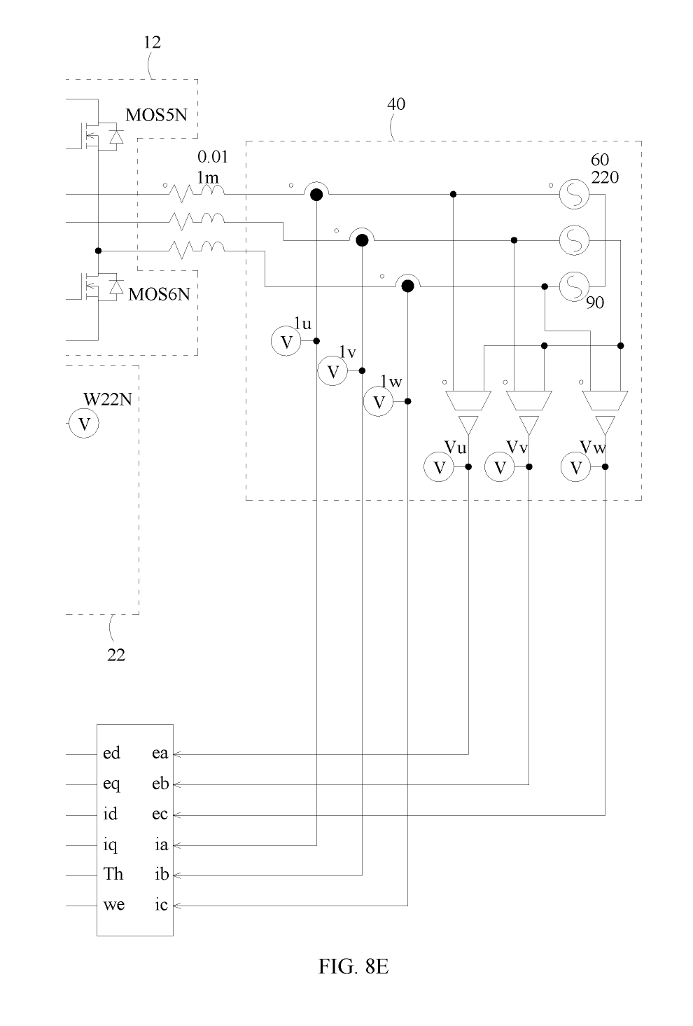

Please refer to FIGS. 8A to 8E, which are the circuit diagrams of an application of a three-phase inverter of another embodiment of the present invention. As shown in FIGS. 8A to 8E, the three-phase inverter 12 is a three-phase six-arm inverter, and each arm is tuned on or off by a MOS transistor, and each MOS transistor is controlled by the control signal from the pulse driving signal controller 22. The pulse driving signal controller 22 can use the sinusoidal modulation method of the present invention to obtain a higher switching efficiency and a better sinusoidal modulation result.

The different between this embodiment and the previous embodiment is that the load terminal of the three-phase inverter 12 is electrically connected to a voltage current detection circuit 40 which can detect three-phase voltages and three-phase currents of the load terminal, and the detected three-phase voltages and currents are converted according to axis coordinate, and the converted three-phase voltage and the current are inputted into the feedback control circuit 50, so as to form a three-phase power factor correction circuit. The phases of the three-phase voltages are different from the phases of the three-phase currents, and the 90° of the phase of current lagging voltage may reduce the power supply efficiency and cause the shift variance of the current waveform. By detecting the three-phase voltages and currents to modify and compensate the phase angle of the current lagging voltage, the output current waveform can be more complete.

The present invention disclosed herein has been described by means of specific embodiments. However, numerous modifications, variations and enhancements can be made thereto by those skilled in the art without departing from the spirit and scope of the disclosure set forth in the claims.

1. A sinusoidal modulation method, adapted to a three-phase inverter comprising three phase arms, wherein each of the three phase arms comprises two bridge arms controlled by a lower bridge transistor and an upper bridge transistor, respectively, and the sinusoidal modulation method comprises:
disposing a pulse driving signal controller electrically connected to the upper bridge transistors and the lower bridge transistors of the three phase arms;
inputting a phase angle and a triangular carrier wave, and calculating duty cycles corresponding to the three phase arms, respectively, according to a modulation index, the phase angle and the triangular carrier wave;
for each of the three phase arms, determining, by using the pulse driving signal controller, whether a sinusoidal control signal corresponding to the phase angle is positive, wherein when the sinusoidal control signal corresponding to the phase angle is positive, the upper bridge transistor is turned on and the lower bridge transistor is turned off, and when the sinusoidal control signal corresponding to the phase angle is not positive, the upper bridge transistor is turned off and the lower bridge transistor is turned on, so that the upper bridge transistor and the lower bridge transistor in each of the three phase arms are turned-on in one half period and turned-off in the other half period for each sinusoidal cycle;
for each of the three phase arms, under a condition that the upper bridge transistor is turned on, determining, by using the pulse driving signal controller, whether the duty cycle is higher than the triangular carrier wave, wherein when the duty cycle is higher than the triangular carrier wave, an upper bridge turn-on signal is outputted to the upper bridge transistor, and when the duty cycle is not higher than the triangular carrier wave, an upper bridge turn-off signal is outputted to the upper bridge transistor; and
for each of the three phase arms, under a condition that the lower bridge transistor is turned on, determining, by using the pulse driving signal controller, whether the duty cycle is higher than the triangular carrier wave, wherein when the duty cycle is higher than the triangular carrier wave, a lower bridge turn-off signal is outputted to the lower bridge transistor, and when the duty cycle is not higher than the triangular carrier wave, a lower bridge turn-on signal is outputted to the lower bridge transistor.

2. The sinusoidal modulation method according to claim 1, wherein the output terminal of the three-phase inverter is serially connected to an inductive circuit comprising an inductor and a resistor, and a phase-shift angle of current lagging voltage is obtained by detecting an inductive reactance of the inductor and a resistance value of the resistor.

3. The sinusoidal modulation method according to claim 2, wherein the phase-shift angle is subtracted from the phase angle.

4. The sinusoidal modulation method according to claim 2, wherein the phase angles of the three phase arms are different from each other by 120°, and the phase-shift angle is about 51.5°.

5. The sinusoidal modulation method according to claim 1, wherein an output terminal of the three-phase inverter is electrically connected to a voltage detection circuit and a current detection circuit configured to detect three-phase voltages and three-phase currents, respectively, and the three-phase voltages and the three-phase currents are transmitted back to the pulse driving signal controller through a feedback control circuit.

6. A three-phase inverter, comprising:
three phase arms, wherein each of the three phase arms comprises two bridge arms, and two bridge arms are controlled by a lower bridge transistor and an upper bridge transistor, respectively; and
a pulse driving signal controller electrically connected the upper bridge transistors and the lower bridge transistors of the three phase arms;
wherein, for each of the three phase arms, the pulse driving signal controller performs the following operations:
determining whether a sinusoidal control signal of a phase angle is positive, and turning on the upper bridge transistor and turning off the lower bridge transistor, or turning off the upper bridge transistor and turning on the lower bridge transistor according to determination result, so that upper bridge transistor and the lower bridge transistor in each of the three phase arms are turned-on in one half period and turned-off in the other half period for each sinusoidal cycle; and
according to whether a duty cycle corresponding to the phase angle is higher than a triangular carrier wave, transmitting a pulse control signal to the turned-on upper bridge transistor or the turned-on lower bridge transistor.

7. The three-phase inverter according to claim 6, wherein an output terminal of the three-phase inverter is serially connected to an inductive circuit comprising an inductor and a resistor.

8. The three-phase inverter according to claim 6, wherein a phase-shift angle of a current lagging the voltage is subtracted from the phase angle.

9. The three-phase inverter according to claim 8, wherein the phase angles of the three phase arms are different from each other by 120°, and the phase-shift angle is about 51.5°.

10. The three-phase inverter according to claim 6, wherein an output terminal of the three-phase inverter is electrically connected to a voltage detection circuit and a current detection circuit configured to detect three-phase voltages and three-phase currents, and the three-phase voltages and three-phase currents are transmitted to the pulse driving signal controller through a feedback control circuit.
